(19) United States
(12) Patent Application Publication
(10) Pub. No.: US 2022/0018371 A1
(43) Pub. Date: Jan. 20, 2022

(54) CLAMPING BIMETAL NON-KEYED SHAFT COLLAR WITH RADIAL MOUNTS

(71) Applicants: Kurt G. Sanner, Irvine, CA (US); Christopher K. Williams, California City, CA (US)

(72) Inventors: Kurt G. Sanner, Irvine, CA (US); Christopher K. Williams, California City, CA (US)

(73) Assignee: T-REX TRACKING CORPORATION, Mojave, CA (US)

(21) Appl. No.: 16/930,899

(22) Filed: Jul. 16, 2020

(51) Int. Cl. F16B 7/04; F16B 2/06

(52) U.S. Cl. CPC F16B 7/0413; F16B 2/065

(57) ABSTRACT

A non-keyed clamping shaft collar with radial mounts is disclosed to provide maximum effective holding force for a mounting clamp against high torque, and which provides a means for precisely locating a counterbalance weight to minimize system torque without requiring any measurements or calculations of system masses or vectors. The counterbalance clamp comprises two concentric rings of different materials. The outer material is strong enough to prevent breaking under a maximum designed clamping force. The inner material has a high coefficient of static friction with the bar onto which it is clamped to prevent slipping after it is clamped. The outer ring has two tapped holes located 180 degrees opposite each other. The clamp enables the use of a lower clamping force, mitigating the potential to deform the bar as a result of the higher coefficient of static friction between the two sliding elements (the bar and the inner ring) being clamped together.

### TECHNICAL FIELD

The embodiments relate to rotating mechanical systems that balance radial loads about a central tube or solid bar (hereafter “bar”). The field of the application given, as an example, is that of camera pointing, target acquisition, directional antenna pointing and tracking systems.

### BACKGROUND

An auto tracking antenna platform is an electromechanical device which holds one or more directional antennas, continuously repositioning them to remain aimed at a moving target. The auto tracking platform may also aim cameras, audio receivers, sonar, or any other type of directional signal device which must be pointed at an object to receive or transmit the desired signal to or from the object. A common method of precisely pointing multiple directional devices at a common target is to attach them onto one common mounting object which is then rotated until all mounted objects are pointing at the target.

One common need among all auto tracking platforms with multiple directional devices is to be able to point all the different types of directional devices at the same target simultaneously. When multiple devices or antennas need to be pointed simultaneously, a bar provides one standard type of mounting surface for those directional items, as the mounting bar can be easily rotated, which in turn simultaneously rotates all of its attached devices. Unfortunately, the physical nature of the objects mounted on the auto tracking platform's mounting places the center of mass of the bar and its attached objects outside the bar, creating a significant torque on the bar. The motor responsible for rotating the bar must hold the bar in a fixed position under a potentially large torque. Therefore, the motors moving the bar must provide enough counter-torque to hold the bar steady. Applying more torque is then required to rotate the mounting bar with its attached mass against the force of gravity, pulling down on the center of mass of the bar and its attached objects. Without a precisely positioned counterbalance sufficient to eliminate the torque on the bar, the large holding torque requirement of the motor results in one of three limitations to using a mounting bar for an auto tracking platform: (1) the system must have mass limitations for the directional devices attached to the mounting bar because the turning motors must operate against the total torque; (2) the maximum speed and acceleration of the system is reduced by the use of reduction gears, which are required to increase the motor torque; (3) large motors are used to ensure sufficient holding torque to hold and rotate the bar and all attached devices without reducing rotational speed and acceleration through reduction gears. The proposed embodiments provide a solution that mitigates these limitations. A precisely mounted counterbalance will move the center of mass of the system back to the center of the axis of rotation, eliminating the need for holding torque. This minimizes the ratio of the reduction gears to just what is needed to enable sufficient rotational acceleration and speed. Lower torque requirements minimize the motor size, since it is no longer needed to have high torque in order to hold the mass in position and enable high rotational acceleration and rotational velocity.

There are many applications for target acquisition systems. One example is radar, which rotates a large radar dish, and which requires precise knowledge of the pointing vector of the dish to accurately calculate the location of objects detected. Automatic antenna tracking systems are another example of a target acquisition system, but which may require multiple antennas to be rotated together. When an airplane is sending telemetry data and video on two frequencies while receiving control commands on a third frequency from the same ground station, each frequency and radio link requires its own antenna to be pointed at the same aircraft as it is moving through the sky. An automatic tracking system that supports multiple antennas is simpler to use and operate than one auto tracking system for each antenna or radio. The antennas have to keep the strongest part of their signals pointing at the airplane in order to maintain a strong video and/or communication link from the airplane to the ground station. This requires the antennas to all be precisely aligned, and to be in alignment with each other. Most antenna trackers can only support either wide beamwidth antennas that do not need precise alignment (due to either lack of precision in the pointing vector or to an inability to track a moving target in real time) or smaller high gain antennas (due to inability of the motors to rotate larger high gain antennas about the axis of rotation), or they are very slow due to the high gear ratios needed because using small motors to hold and turn a large torque without proper counterbalance forces them to be slow moving systems. Only a precisely oriented counterbalance allows a small motor to hold, rapidly accelerate, and rotate a large mass about a central axis of rotation.

Having a low gain, wide beamwidth radio signal limits the range those antennas can pick up or send a strong signal. A narrower beamwidth will concentrate the energy in a more focused beam, allowing the energy to dissipate more slowly than a wider beamwidth antenna. A narrower beamwidth antenna will also be able to pick up smaller signals and signals from a further distance than will a wider beamwidth antenna. Therefore, narrower beamwidth antennas enable further range of operations from a fixed ground control location, but they also require more precise aiming of those antennas. The narrower the beamwidth of the antenna, the more precisely the antenna must be aimed; however, those narrow beamwidth antennas come in physically large structures, which overwhelm the motors of small auto tracking platforms. The solution is to counter the torque of the antennas, cameras, and other objects attached to the auto tracker's mounting bar with a special clamp that can hold enough mass in the proper position to make the total torque of the mass on the mounting bar negligible.

Because the counterweight attached to the clamping bimetal non-keyed shaft collar with radial mounts (hereafter “counterbalance clamp”) must be capable of being positioned anywhere around the mounting bar to properly counterbalance the attached antennas and other devices, the counterbalance clamp cannot be keyed. One possible solution is to drill spiral grooves (like a screw) into the shaft of the mounting bar, and corresponding spiral grooves into the inside of the counterbalance clamp. That would enable the counterbalance clamp to have continuous position capability (with the assistance of two side locking screws). The problem with this solution is the difficulty with aligning the counterbalance properly. An easier, quicker field solution is to allow gravity to rotate the mounting bar and its attached devices so that the center of mass of the system must point directly down. Gravity will also rotate the counterbalance clamp with a weight one point pulled directly down. This causes an opposing attachment point on the counterbalance clamp to point directly up. The counterbalance clamp could not freely rotate under gravity in the threaded-rod design as the threaded rod adds significant friction, unless one of the surfaces has an extremely low coefficient of friction; however, that would prevent the clamp from gripping when it needs to be locked into position on the bar. Therefore, the counterbalance clamp must maintain its position with friction force when it is clamped, but it must rotate about the bar when it is not clamped in order to align it properly.

Non-keyed shaft collars made of carbon steel and other materials to perform this function do exist, but they are not ideal. The torque required to break a shaft collar free from its clamped position is directly proportional to the normal force (clamping pressure) and the coefficient of static friction of the shaft collar material and the bar. The material with this highest coefficient of static friction with an aluminum mounting bar is aluminum; however, aluminum is not as strong as carbon steel, which can be clamped with much more force than aluminum. Therefore, most bar clamps are made of carbon steel, or other hard materials, since it won't break under large clamping loads, even though it does not have as high a holding force with the same normal force (clamping force) as a weaker aluminum bar clamp would have.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments disclosed herein provide a non-keyed clamping shaft collar with radial mounts, comprising an inner sheath constructed of a material of a high static coefficient of friction when contacting a bar. An outer sheath is constructed of a sufficiently resilient material, wherein the inner sheath and outer sheath form concentric rings. The inner sheath and outer sheath function as a clamp to retain the bar within an inner space of the inner sheath.

In one aspect, the inner sheath is constructed of a material of maximum coefficient of friction with the bar, for example, aluminum for an aluminum bar.

In one aspect, the outer sheath is constructed of a sufficiently strong material that will support clamping force, such as black oxide stainless steel.

In one aspect, the outer sheath comprises a top and a bottom each including a cutout.

In one aspect, tapped mounting holes are positioned on the top and the bottom.

In one aspect, a keyway is cut into the inner sheath and the outer sheath to prevent rotation therebetween. The aspect is an example of a method to prevent rotation between the inner and outer rings, but there are various methods of preventing the rotation between the inner and outer rings, any of which may be used to achieve this feature.

In one aspect, an inner cut is at least partially through the inner sheath and the outer sheath to permit opening of the clamp to receive the bar. The inner cut may not be required for a sufficiently thin inner ring material, but is shown for the example given with a very thick inner metal ring.

In one aspect, a pass-through cut through the outer sheath and the inner sheath allows for the opening of the clamp via the bending permitted by the inner cut.

In one aspect, at least one threaded hole receives a screw. At least one threaded hole comprises an outer diameter bore to receive the head of the screw.

The embodiments provide a single device consisting of a clamping bimetal non-keyed shaft collar with radial mounts consisting of an inner ring made of aluminum, which provides the highest coefficient of static friction with aluminum, and an outer ring made of carbon steel to provide extremely strong clamping force. It is another object of the present embodiments to provide a clamping bimetal non-keyed shaft collar that holds a removable measured weight on the outside diameter of the collar, enabling it to freely rotate under gravity when not clamped to the bar, and which then forms a self-aligning counterbalance clamp by rotating a second attachment point for the counterbalance weight to point directly up. It is another object of the present embodiments to provide a removable and attachable counterbalance bar to the clamping bimetal non-keyed shaft collar enabling the alignment of the counterbalance weight without any measurement of the mass of any attached objects, and without any calculations of the counterbalance vector. It is another object of the present embodiments to provide the easy alignment of the position of the counterbalance mass quickly while in the field and by an unskilled person in order to quickly remove applied torque about the axis of the mounting bar.

The present invention provides a field-installable, precision counterbalance solution with which small motors can drive large rotating loads when mounted on a common rotating horizontal bar off the central axis of rotation.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the clamping bimetal non-keyed shaft collar with radial mounts, according to some embodiments;

FIG. 2 illustrates a top plan view of the clamping bimetal non-keyed shaft collar with radial mounts, according to some embodiments;

FIG. 3 illustrates a front elevation view of the clamping bimetal non-keyed shaft collar with radial mounts, according to some embodiments; and

FIG. 4 illustrates a side elevation view of the clamping bimetal non-keyed shaft collar with radial mounts, according to some embodiments.

### DETAILED DESCRIPTION

The specific details of the single embodiment or variety of embodiments described herein are to the described apparatus. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the apparatus. Accordingly, the apparatus components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The specific details of the single embodiment or variety of embodiments described herein are set forth in this application. Any specific details of the embodiments are used for demonstration purposes only, and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements.

The embodiments provide a tracking antenna platform that holds multiple interchangeable antenna elements and cameras, all mounted on the same bar, and all pointed at the same moving object. The specific application area for the embodiments is the mounting device that attaches the counterweight onto the same bar as the other components and in a manner that ensures all radial loads are balanced about the central axis of the bar, thereby eliminating torque on the bar from the mounted antennas, cameras, and other components. Due to the variation in masses of the innumerable variety of cameras and antennas that can be mounted onto the rotating bar, the location of the center of mass of the combined set of attached objects could be at any location about the axis of rotation. Therefore, an effective counterbalance requires the capability of being fixed at any degree of rotation about the bar. This negates the ability to use a key to attach the counterbalance at a predetermined fixed location.

The embodiments include a non-keyed clamping shaft collar with radial mounts to provide maximum effective holding force for a mounting clamp against high torque, and which provides a means for precisely locating a counterbalance weight to minimize system torque without requiring any measurements or calculations of system masses or vectors. The counterbalance clamp generally comprises two concentric rings of different materials. The outer material is strong enough to prevent breaking under maximum designed clamping force. The inner material has a high coefficient of static friction with the bar onto which it is clamped to prevent slipping after it is clamped. The outer ring has two tapped holes located 180 degrees opposite each other. One of the two tapped holes is used to temporarily hold a threaded rod, causing the shaft collar to rotate under gravity until it points straight down. When the threaded rod is pointed straight down, the non-keyed clamping shaft collar with radial mounts is tightened via the clamping bolt, and the counterbalance weight on another threaded rod is placed in the opposite tapped hole pointing straight up. At this point, the first threaded rod is removed, and weight on the upper threaded rod is adjusted in or out as needed until the mounting bar freely rotates, indicating the center of mass of the system in located in the center of the rotating bar, with no net torque on the bar. This enables the use of higher torque loads which may be held by smaller motors, with all the motor torque going to accelerating and rotating the bar. This also enables the use of a lower clamping force, mitigating the potential to deform the bar as a result of the higher coefficient of static friction between the two sliding elements (the bar and the inner ring) being clamped together.

The improved non-keyed shaft collar may be used as a bar clamp that locks two concentric metal discs together to prevent slipping, which uses an inner metal disc with a higher coefficient of friction, and an outer metal disc with higher strength, and further having built-in tapped holes allowing the mounting of counterbalance weights and alignment weights, for the purpose of enabling continuous rotation of the counterbalance weight without slipping as the bar is rotated about its axes as a tracking platform moves its antennas and devices to track a moving target.

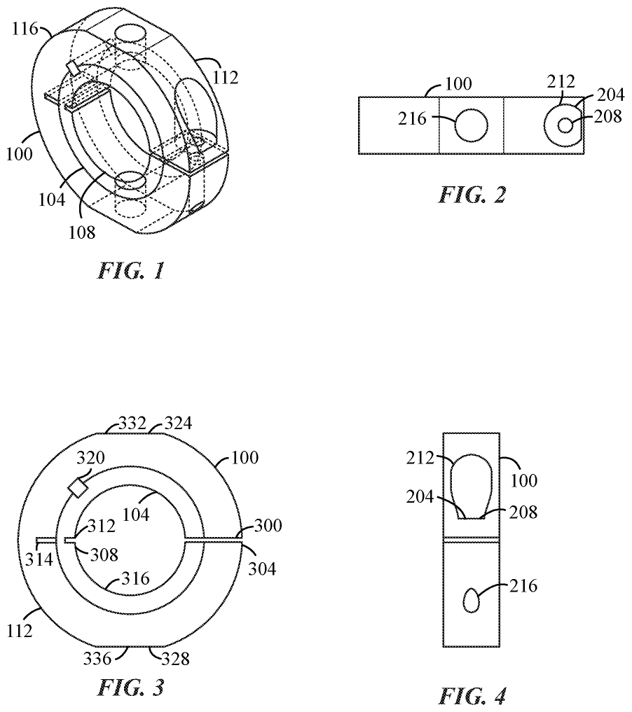

FIG. 1 illustrates the clamping bimetal non-keyed shaft collar with radial mounts (hereinafter “shaft collar” or “clamp”) 100 which includes an inner sheath 104 to create a high coefficient of static friction with a mounting bar (not shown), which it is clamped onto. The inner sheath 104 may be constructed of aluminum or other metal, metalloid, metal alloy or the like to provide the maximum coefficient of friction between the inner sheath 104 and the mounting bar. The inner sheath 104 forms the inner circumference 108 of the clamp 100, which contacts the mounting bar during use. An outer sheath 112 forms the outer circumference 116 of the clamp 100. The outer sheath 112 may be constructed of black oxide stainless steel or similar resilient material providing a suitable strength to the clamp 100 during use. In such, the inner sheath 104 is constructed of a first material, and the outer sheath 112 is constructed of a second material.

The inner sheath 104 and outer sheath 112 form concentric rings wherein the inner sheath 104 is positioned within the circumference of the outer sheath 112 such that tightening the outer sheath causes the inner sheath to decrease in circumference and retain a member disposed within the interior space thereof. The user may selectively tighten the clamp 100 to provide varying amounts of pressure onto the member to secure the member within the interior space of the inner sheath 104. The aluminum inner sheath 104 provides a surface having a high coefficient of friction to aid in retaining the member therein without the use of excess compressive force, which otherwise may damage the member if the clamp 100 is overtightened. Further, the inner sheath 104 deters sliding of the member during use.

FIG. 2 illustrates a top plan view and FIG. 4 illustrates a side elevation view of the clamp 100, which includes a first threaded hole 204 having an inner surface 208 to receive a clamping screw via a threaded engagement. The outer diameter bore 212 at least partially receives the clamping screw head. Tapped mounting holes 216 are positioned on the top and bottom, located 180 degrees apart from one another. A first mounting hole will temporarily hold a small weight used to make gravity rotate the clamp in order to pull the weight straight down, forcing the opposing tapped mounting hole to point straight up.

FIG. 3 illustrates the clamp 100 including the pass-through cut 300 in both the inner sheath 104 and the outer sheath 112 to allow for the clamping function of the clamp 100 and to provide a sufficient force imparted by the inner sheath 104 onto a surface. The pass-through cut 300 allows the first side 304 to open and close by pivoting about pivot point 308 using first inner cut 312 and second inner cut 314 at least partially through the inner sheath 104 and the outer sheath 112. The inner cut 312 allows for both the inner sheath 104 and outer sheath 112 to bend to receive a member within the interior space 316 of the clamp 100. A keyway 320 is cut into both the inner sheath 104 and the outer sheath 112 to prevent rotation between the inner sheath 104 and outer sheath 112. First and second cutouts 324,328 are positioned on the top and bottom 332,336 of the clamp 100.

The above-described system is an improvement over conventional non-keyed shaft collars (clamps) due to: (1) the use of two metals giving the simultaneous advantages of maximum coefficient of static friction, (2) maximum strength enabling highest clamping force, (3) providing maximum holding torque for a given clamping force, (4) allowing gravity to align the counterbalance-attached shaft collar without needing additional tools, (5) allowing the attachment of counterbalance weight in the precise vector needed to attach the counterbalance weight to place the center of mass of the rotating system inside the rotating bar, and (6) minimizing the setup time and enabling toolless setting of the counterbalance, which provides the desired goals of field maintainability and of minimizing torque, enabling the use of smaller, lighter, cheaper motors.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A non-keyed clamping shaft collar with radial mounts, comprising:
an inner sheath constructed of a material of a high static coefficient of friction when contacting a bar; and
an outer sheath constructed of a sufficiently resilient material, wherein the inner sheath and outer sheath form concentric rings, and wherein the inner sheath and outer sheath function as a clamp to retain the bar within an inner space of the inner sheath.

2. The non-keyed clamping shaft collar of claim 1, wherein the inner sheath is constructed of aluminum.

3. The non-keyed clamping shaft collar of claim 1, wherein the outer sheath is constructed of stainless steel.

4. The non-keyed clamping shaft collar of claim 3, wherein the outer sheath is constructed of black oxide stainless steel.

5. The non-keyed clamping shaft collar of claim 1, wherein the outer sheath comprises a top and a bottom, each including a cutout.

6. The non-keyed clamping shaft collar of claim 5, further comprising tapped mounting holes positioned on the top and the bottom.

7. The non-keyed clamping shaft collar of claim 1, further comprising a keyway cut into the inner sheath and the outer sheath to prevent rotation therebetween.

8. The non-keyed clamping shaft collar of claim 1, further comprising an inner cut at least partially through the inner sheath and the outer sheath to permit opening of the clamp to receive the bar.

9. The non-keyed clamping shaft collar of claim 8, further comprising a pass-through cut through the outer sheath and the inner sheath to allow for the opening of the clamp via bending as permitted by the inner cut.

10. The non-keyed clamping shaft collar of claim 1, further comprising at least one threaded hole to receive a screw.

11. The non-keyed clamping shaft collar of claim 10, wherein the at least one threaded hole comprises an outer diameter bore to receive the head of the screw.

12. A non-keyed clamping shaft collar with radial mounts, comprising:
an inner sheath constructed of a material of a high static coefficient of friction when contacting a bar disposed within the inner space of the inner sheath; and
an outer sheath constructed of a sufficiently resilient material to provide a compressive force to the inner sheath, wherein the inner sheath and outer sheath form concentric rings, and wherein the inner sheath and outer sheath function as a clamp to retain the bar within an inner space of the inner sheath.

13. The non-keyed clamping shaft collar of claim 12, wherein the inner sheath is constructed of aluminum.

14. The non-keyed clamping shaft collar of claim 13, wherein the outer sheath is constructed of black oxide stainless steel.

15. The non-keyed clamping shaft collar of claim 14, wherein the outer sheath comprises a top and a bottom, each including a cutout, the top and bottom comprising tapped mounting holes.

16. The non-keyed clamping shaft collar of claim 15, further comprising a keyway cut into the inner sheath and the outer sheath to prevent rotation therebetween.

17. The non-keyed clamping shaft collar of claim 16, further comprising an inner cut at least partially through the inner sheath and the outer sheath to permit opening of the clamp to receive the bar.

18. The non-keyed clamping shaft collar of claim 17, further comprising a pass-through cut through the outer sheath and the inner sheath to allow for the opening of the clamp via bending as permitted by the inner cut.

19. The non-keyed clamping shaft collar of claim 18, further comprising at least one threaded hole to receive a screw, and wherein the at least one threaded hole comprises an outer diameter bore to receive the head of the screw.

20. A non-keyed clamping shaft collar with radial mounts, comprising:
an inner sheath constructed of a material of a high static coefficient of friction when contacting a bar disposed within the inner space of the inner sheath, wherein the bar is a mounting surface, and wherein the bar is a counterbalance weight to a removeable weight positioned on the non-keyed clamping shaft collar; and
an outer sheath constructed of a sufficiently resilient material to provide a compressive force to the inner sheath, wherein the inner sheath and outer sheath form concentric rings, and wherein the inner sheath and outer sheath function as a clamp to retain the bar within an inner space of the inner sheath.
